(19) United States
(12) Patent Application Publication
(10) Pub. No.: US 2016/0311266 A1
(43) Pub. Date: Oct. 27, 2016

(54) TREAD BAND HAVING BLOCKS AND FINE GROOVES ON THE BLOCKS

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Shuichi KANEKO, Tokyo (JP)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/105,070

(22) PCT Filed: Dec. 15, 2014
(86) PCT No.: PCT/EP2014/077709

§ 371 Date: Jun. 16, 2016

(30) Foreign Application Priority Data
Dec. 17, 2013 (FR) 1362808

(51) Int. Cl. B60C 11/13; B60C 11/12

(52) U.S. Cl. CPC B60C 11/1346; B60C 11/1236; B60C 11/1259; B60C 2011/1231; B60C 2011/1245

(57) ABSTRACT

The disclosure relates to a tread band made of rubber-like material for a tire for winter travel. The tread band comprises a plurality of blocks with each block including a contact face designed to come into contact with the ground when the tire travels, the contact face having a plurality of sipes lot fined therein and a plurality of fine grooves shallower than the sipes. Each block includes a least one lateral face, this lateral face is covered by a covering material, the covering material having a modulus of elasticity which is greater than the modulus of elasticity of the rubber-like material forming the block.

### CROSS-REFERENCE TO RELATED APPLICATIONS

This application is a 371 national phase entry of PCT/EP2014/077709, tiled 15 Dec. 2014, which claims the benefit of French Patent Application No. 1362808, filed 17 Dec. 2013, the contents of which are incorporated herein by reference for all purposes.

### BACKGROUND

The present disclosure relates to a pneumatic tire suitable for ice-bound or snow covered roads, and more particularly to a pneumatic tire for ice-bound or snow covered roads, which has tine grooves formed in a tread surface.

Document WO 03089257 discloses a pneumatic tire which has line grooves formed in a tread surface for improve brake and drive performance on ice-bound roads in early periods of wear, and which prevents snow clogging in the fine grooves, thereby enabling a further enhancement of the effect of improving the brake and drive performance. The depth of the fine groove lies between 0.1 and 0.8 mm, the width of the fine groove lies between 0.1 and 0.8 mm and the pitch of these fine grooves lies between 0.5 and 2.0 mm.

It is an object of the prevent disclosure to more improve, in early periods of wear, brake and drive performance of a pneumatic tire comprising fine grooves.

“Tire” is understood as any type of elastic tire whether it is subjected to an internal pressure or not.

“Snow tire” or “winter tire” is understood as a tire identified by the letters M+S or M.S or even M&S, marked on at least one of the sidewalls of the tire. Said snow tire is characterized by a design of the tread and a rubber composition which is primarily designed to provide, in mud and fresh or melting snow, improved behaviour than that of a road type tire designed to travel on ground which is not covered with snow.

“Tread” of a tire is understood as a quantity of rubber material defined by lateral surfaces and by two principal surfaces, one thereof being designed to come into contact with a road surface when the tire is travelling.

“Block” is understood as relief element limited by some large grooves. Each block comprises a plurality of lateral faces and a contact face which is able to come into contact with the road when the tire is roiling.

“Modulus of elasticity” of an elastic material is understood as the relationship between the variation in stress and the variation in deformation when said material is subjected to tractive or compressive forces.

### SUMMARY

The disclosure relates to a tread band made of rubber-like material for a tire for winter travel. This tread band comprising a plurality of blocks, each block comprising a contact face designed to come into contact with the ground when the tire travels, the contact face having a plurality of sines formed therein and a plurality of fine grooves shallower than the sines. Each block comprises a least one lateral fare, this lateral face is covered by a covering material, the covering material having a modulus of elasticity which is greater than the modulus of elasticity of the rubber-like material forming the block.

The covering material increases the overall rigidity of the block, improving thus the action of the fine grooves on snow and ice. Consequently, brake and drive performance of a pneumatic tire is improved.

In a variant, the fine grooves do not extend until the covering material.

Creation of cracks in the covering material is thus limited.

In a variant, the fine grooves extend obliquely.

It is possible to improve the action of the fine grooves on snow and ice, particularly, during a braking in a bend.

In a preferred embodiment, the covering material comprises an elastomeric material of which the dynamic shear modulus G* subjected to a maximum alternating stress of 0.7 MPa, at a frequency of 10 Hz and at a temperature of −10° C., is greater than 200 MPa and preferably greater than 300 MPa.

By using a covering material with such features, we improve the ability of the block to scrap the snow and ice on the road. Consequently, the adherence on a snow/ice road is improved.

In a variant, the covering material comprises an assembly of fibers.

By using fibers, we improve the resistance of the covering material.

### BRIEF DESCRIPTION OF THE DRAWINGS

Other features and advantages of the disclosure will emerge from the following description, given by way of nonlimiting example, with reference to the attached drawings in which:

FIG. 1 schematically depicts a block of a tread band according to the disclosure;

FIG. 2 is a cut view along the line A-A′ of the FIG. 1;

FIG. 3 schematically depicts a block of a tread band according to a second embodiment of the disclosure;

FIG. 4 schematically depicts a block of a tread band according to a third is embodiment of the disclosure.

### DETAILED DESCRIPTION

In the description that follows, elements that are substantially identical or similar will be denoted by identical references.

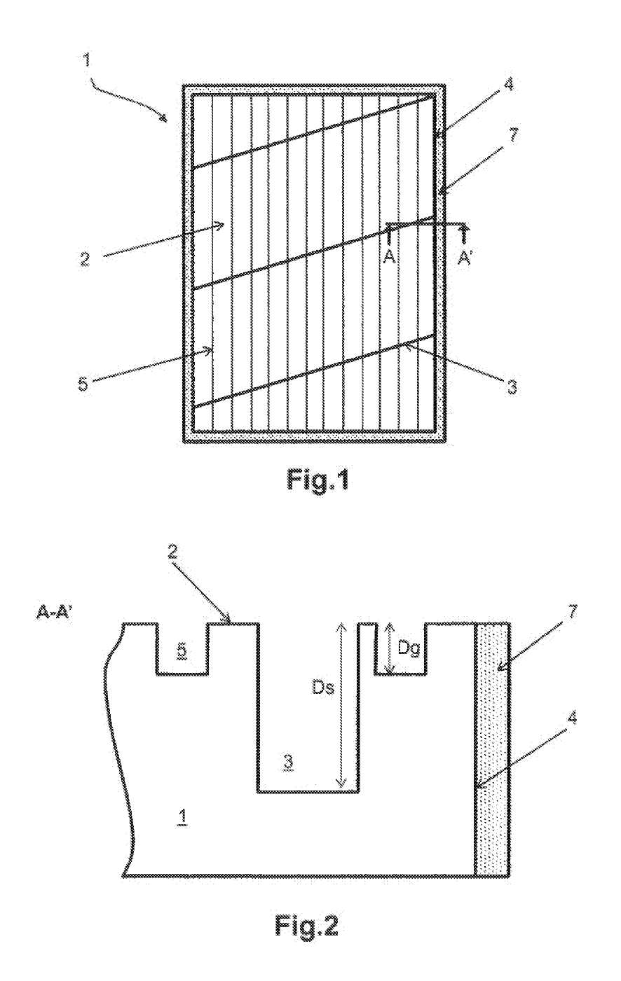

FIG. 1 depicts a block 1 of a tread band. This block 1 is made of rubber-like material for a tire for a winter travel. The block I comprises a contact face 2 designed to come into contact with the ground when the tire travels. This contact face 2 has a plurality of sipes 3. Indeed, this contact face 2 has a plurality of fine grooves 5.

FIG. 2 is a cut view along a line A-A′ in the FIG. 1. In this view, we can notice that the depth Dg of the fine grooves 5 is less important than the depth Ds of the sipe 3. Indeed, the width of the fine grooves is smaller than the width of the sipe 3. More particularly, the depth of the fine groove lies between 0.1 and 0.8 mm, the width of the fine groove lies between 0.1 and 0.8 mm and the pitch of these fine grooves lies between 0.3 and 3.0 mm. In a variant, the width of the fines grooves are equal to the width of the sipe 3.

The block 1 in the FIGS. 1 and 2 comprises four lateral faces 4. These lateral faces 4 are covered by a covering material 7. The covering material has a modulus of elasticity which is greater than the modulus of elasticity of the rubber-like material forming the block 1.

More particularly, the covering material comprises an elastomeric material of which the dynamic shear modulus G* subjected to a maximum alternating stress of 0.7 MPa, at a frequency of 10 Hz and at a temperature of −10° C., is greater than 200 MPa and preferably greater than 300 MPa. In the present document, the terms “modulus of elasticity G′” and “modulus of viscosity G″” denote the dynamic properties well known to the person skilled in the art. Said properties are measured on a Metravib VA4000 viscoanalyser on test specimens moulded from raw compositions. Test specimens such as those described in the ASTM D 5992-96 standard (version published September 2006, initially approved in 1996) in the figure X2.1 (circular embodiment) are used. The diameter of the test specimen is 10 mm (thus it has a circular section of 78.5 mm²), the thickness of each of the portions of rubberlike composition is 2 mm, which provides a “diameter to thickness” ratio of 5 (in contrast to the ISO 2856 standard, cited in the ASTM standard, paragraph X2.4 which recommends a d/t value of 2). The response of a test specimen of a vulcanized rubber-like composition subjected to simple alternating sinusoidal shear stress, at a frequency of 10 Hz, is recorded. The test specimen is subjected to sinusoidal shear stress at 10 Hz, at controlled stress (0.7 MPa) symmetrically around its position of equilibrium. The measurement is carried out during a temperature ramp increasing by 1.5° C. per minute, from a temperature Tmin lower than the glass transition temperature (Tg) of the material, up to a temperature Tmax which may correspond to the rubber plateau of the material. Before starting the scanning, the test specimen is stabilized at the temperature Train for 20 minutes to reach a uniform temperature within the test specimen. The result used is the dynamic shear modulus of elasticity (G′) and the shear modulus of viscosity (G″) at the selected temperatures (in this case 0°, 5° and 20° C.). The “complex modulus” G* is defined as the absolute value of the complex sum of the modulus of elasticity G′ and the modulus of viscosity G″: G′=\sqrt{(G′²+G″²)}.

In a variant, the elastomeric material of the covering layer comprises a composition based on at least one diene elastomer which is very highly laden with sulphur, such as ebonite.

In a variant, the covering material comprises an assembly of fibers, for example a three-dimensional assembly of fibres forming a felt. The fibres of said felt may be selected from the group of textile fibres and mineral fibres and a mixture thereof. It is also noteworthy that the fibres of said felt may be selected from textile fibres of natural origin, for example from the group of silk, cotton, bamboo, cellulose, wool fibres and mixtures thereof.

In a further variant, the elastomeric material of the covering layer comprises a composition based on at least one thermoplastic polymer, such as polyethylene terephthalate (PET). Such a polymer may have a Young's modulus of more than 1 GPa.

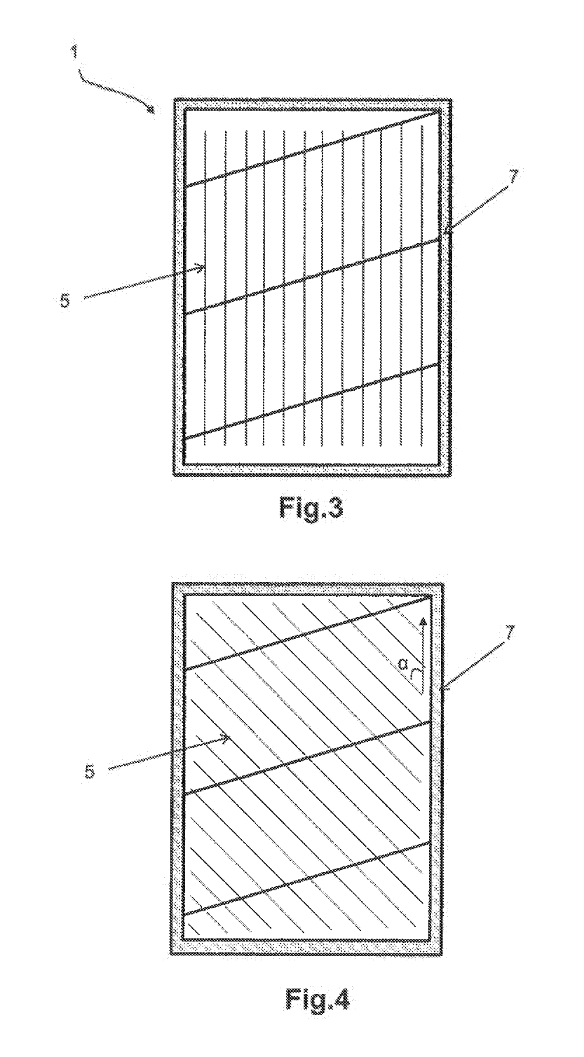

FIG. 3 depicts a block 1 of a tread band according to a second embodiment of the disclosure. In this second embodiment, the fine grooves 5 do not extend until the covering material 7.

FIG. 4 depicts a block 1 of a tread band according to a third embodiment of the disclosure. In this third embodiment, the fine grooves 5 extend obliquely. Thus, the angle α between the tine groove and a circumferential direction X, is less than 20°, More particularly, this angle α is less than or equal to 10°.

The disclosure is not restricted to the examples described and depicted and various modifications can be made thereto without departing from its scope.

FIG. 1 and FIG. 2 depict a block having lateral faces entirely covered by the covering material. In a variant, the lateral faces are partially covered by the covering material.

FIG. 3 and FIG. 4 depict different embodiment in which the sipes and the fine grooves have between them a certain angle. All of angle combinations are possible between the sipes and the fine grooves.

1. A tread hand made of rubber-like material for a tire for winter travel, comprising:
a plurality of blocks, each of the plurality of blocks having contact face designed to come into contact with the ground when the tire travels, the contact face having a plurality of sipes formed therein and a plurality of fine grooves shallower than the sipes,
wherein each block includes a least one lateral face, the lateral face being covered by a covering material, the covering material having a modulus of elasticity which is greater than the modulus of elasticity of the rubber-like material forming the block.

2. The tread band according to claim 1, wherein the fine grooves extend after the covering material.

3. The read band according to claim 1, wherein the fine grooves extend obliquely.

4. The tread band according to claim 1, wherein the covering material includes an elastomeric material of which the dynamic shear modulus G* subjected to a maximum alternating stress of 0.7 MPa, at a frequency of 10 Hz and at a temperature of −10° C., is greater than 200 MPa and preferably greater than 300 MPa.

5. The tread band according to claim 1, wherein the covering material includes an assembly of fibers.
